(19) United States
(12) Patent Application Publication
(10) Pub. No.: US 2010/0226555 A1
(43) Pub. Date: Sep. 9, 2010

(54) COUNTERTOP ULTRASOUND IMAGING DEVICE AND METHOD OF USING THE SAME FOR PATHOLOGY SPECIMEN EVALUATION

(76) Inventors: Robert E. Sandstrom, Longview, WA (US); Lawrence A. Crum, Bellevue, WA (US)

Correspondence Address: Timothy E Siegel Patent Law, PLLC, 777 108th Avenue, Suite 2240, Bellevue, WA, 98004-5178, US

(21) Appl. No.: 12/716,991

(22) Filed: Mar. 3, 2010

Related U.S. Application Data
(60) Provisional application No. 61/209,202, filed on Mar. 4, 2009.

(51) Int. Cl. G06K 9/00; G01N 29/06; G01N 29/04

(52) U.S. Cl. 382/131; 73/618; 73/596; 73/632

(57) ABSTRACT

A tissue specimen imaging device, comprising: a container having an upwardly facing surface, adapted to receive a tissue specimen and a liquid, an ultrasound imaging assembly, adapted to automatically form a three dimensional image of the tissue specimen interior. In one preferred embodiment the device includes a transducer head that is automatically moved relative to the specimen.

### RELATED APPLICATION

This application claims priority from provisional application Ser. No. 61/209,202, filed Mar. 4, 2009.

### BACKGROUND

Pathologists typically examine tissue specimens in a laboratory setting. For each tissue specimen an initial visual inspection is made. If different types of tissue are visible, for example healthy tissue and diseased tissue, a smaller tissue sample may be taken from one or more tissue types, to permit examination under a microscope. If no tissue differentiation is immediately apparent, the pathologist will typically cut into the specimen, in search of diseased tissue. This practice is destructive to the specimen and may result in the loss of some otherwise obtainable information. For example information about the size and shape of a tumor may be lost during this process. It may also be challenging to find the diseased tissue. For example a lymph node tumor metastasis may be so small that it could be easily missed, even if several cuts are taken through a tissue specimen that includes a lymph node. Depending on the purpose of the tissue specimen examination, each microscope slide prepared may be an investment of between 5 and 20 minutes of a technician's time. The decision on which portion of the specimen to take tissue for the preparation of microscope slides determines whether or not this investment is effective, and more importantly whether the examination of the tissue specimen yields a benefit to the patient. Accordingly, it would be desirable to have some device and method to help a pathologist examine the interior of a specimen for instances of abnormal tissue, without destroying the specimen by cutting into it repeatedly.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In a first separate aspect, the present invention takes the form of a tissue specimen imaging device, comprising: a container having an upwardly facing surface, adapted to receive a tissue specimen and a liquid, an ultrasound imaging assembly, adapted to automatically form a three dimensional image of the tissue specimen's interior.

In a second separate aspect, the present invention takes the form of a method of examining a tissue specimen, which uses an ultrasound device capable of automatically forming an interior image of the tissue specimen. The method starts with using the device to automatically form an interior image of the tissue specimen and then further studying sections of the tissue specimen in reliance on the interior image.

In a third separate aspect, the present invention takes the form of a method of communicating with a lab technician to indicate where on a tissue specimen to take tissue sections. The method includes displaying an electronic three-dimensional interior image of the tissue specimen and electronically marking on the three dimensional interior image of the tissue specimen to indicate desired location of tissue section.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced drawings. It is intended that the embodiments and figures disclosed herein are to be considered illustrative rather than restrictive.

FIG. 1 is a perspective view of an imaging device according to the present invention.

FIG. 2 is a side elevation sectional view of the imaging device of FIG. 1.

FIG. 3 is a perspective view of an imaging device similar to that of FIG. 1, with the imaging head turned relative to its position in FIG. 1 and including a robot arm.

FIG. 4 is a perspective view of an alternative embodiment of an imaging device, having two transducer arrays.

FIG. 5 is a top perspective view of an alternative embodiment of an imaging device according to the present invention, having a two-dimensional ultrasound transducer placed below a tissue specimen.

FIG. 6 is a front elevational view of a display forming a part of an imaging assembly according to the present invention, showing a tissue specimen, having a location marked.

### DETAILED DESCRIPTION OF THE PREFERRED EMBODIMENTS

A preferred embodiment of the present invention is an ultrasound imaging device 10 that can easily be supported by a flat surface, such as a laboratory countertop, and which can accept and image a tissue specimen. The device includes a base 12 supporting a container 14, in which a specimen 13 may be placed, and which may be filled with saline solution 16. A linear imaging array 18, having for example 256 piezoelectric elements is mounted on a rack system 20, that includes electric motors 22, for moving array 18 in three dimensions. In an alternative preferred embodiment a capacitive micro-machined ultrasonic transducer (CMUT) array is used. In an alternative preferred embodiment, array 18 is vertically moveable, to place it into the saline solution and is moveable in the horizontal direction that is orthogonal to the length of the array 18, with resolution in the dimension along the length of the array provided by electronic scanning.

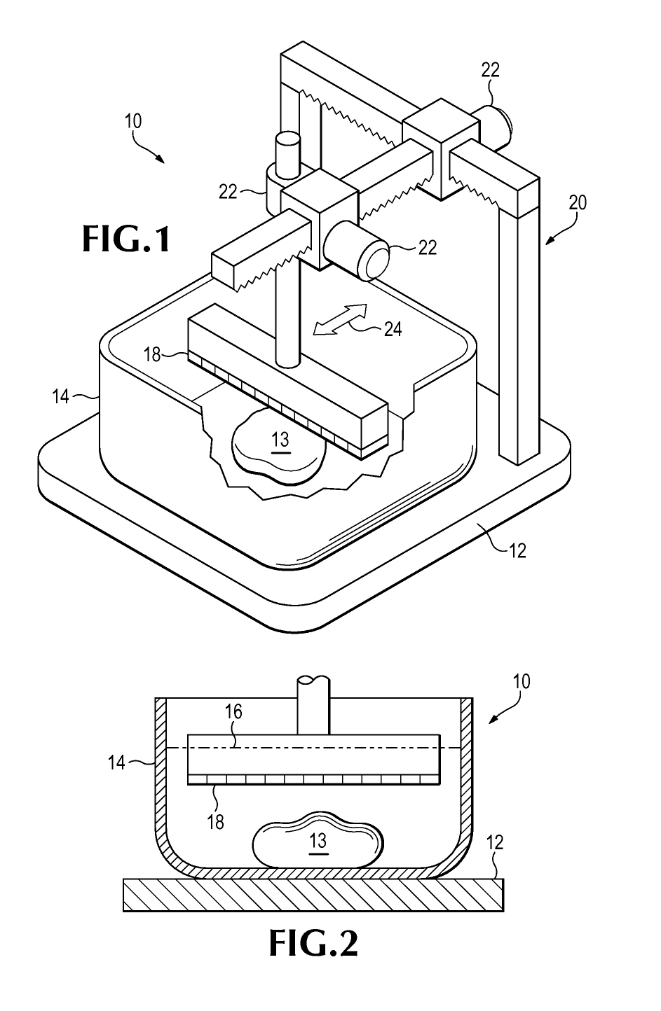

In operation, the specimen 13 is placed into the bath of saline solution 16 and the array 18 is lowered, or partial enclosure 14 is raised, so that the lower portion of array 18 is immersed in the saline solution 16. This reduces boundary and low-transmission effects, as the boundary between saline solution and a tissue specimen is typically not as reflective as the boundary between air and a tissue specimen. In an alternative embodiment the partial enclosure is filled with a biocompatible gel, into which the tissue specimen 13 is placed. In yet another preferred embodiment the array is brought into contact with the specimen, either with the assistance of a human operator or automatically by a system that includes sufficient sensing and intelligence to bring the probe into contact with the tissue specimen, without harming or significantly distorting the tissue specimen. In one preferred embodiment, the array is covered by an ultrasound substantially transparent material, to protect it. The linear piezoelectric array is scanned past the specimen 13 in a first dimension 24 (FIG. 1), imaging as it scans.

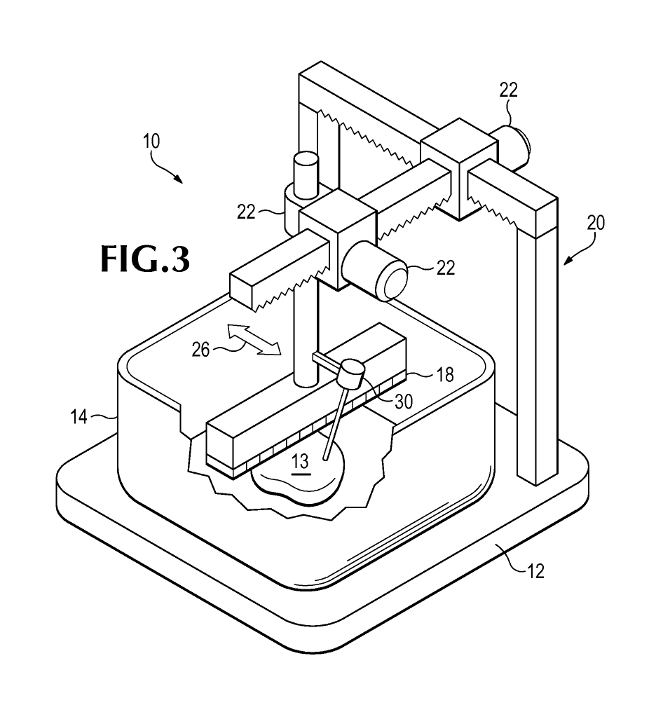

Although the electrical connections are not shown in the physical drawings provided herein, as is well known in the art the piezoelectric elements of array 18 are electrically driven to produce a sound signal having a wavelength in the 85-770 micron range (2-18 MHz). These sound waves travel through the specimen 13 until reflected by some change in tissue quality. Container 14 is made of a material that is highly absorptive to ultrasound waves and is as unreflective of ultrasound waves as possible. After transmitting, array 18 is switched to receive mode and the timing of the received ultrasound signals indicates the depth into tissue specimen 13 at which the ultrasound waves were reflected. Array 18 may be electrically focused to form a beam that is scanned in dimension 26 (FIG. 3), for the configuration shown in FIG. 1. Accordingly, at each position of array 18, a two-dimensional slice of data, into the specimen can be found by a data processing assembly (not shown). The dimensions are depth, into the specimen, and dimension 26 (see FIG. 3). In one preferred embodiment, a mechanical scan in only dimension 24 is performed, with the electronic scanning providing resolution in dimension 26. But in an additional preferred embodiment, as shown in FIG. 3, array 18 is rotated by 9020 and is scanned across specimen 13 along dimension 26, with high resolution cells formed in dimension 24. The two scans are reconciled by the data processing assembly to arrive at a high resolution 3-dimensional image. In this embodiment, ensuring that the specimen does not move or is displaced or distorted between the two scans is important. Accordingly, in one preferred embodiment anti-vibration technology is used to cancel any vibrations that would otherwise change the position of specimen 13. In one preferred embodiment, structure 20 is mounted separately from base 12, so that vibrations from the movement of array 18 are further isolated from specimen 13.

The embodiment of FIGS. 1 and 2, as well as other embodiments disclosed, are very helpful in finding foreign bodies within a tissue specimen, particularly when used near the surgical theater. A surgeon may have difficulty determining in an entire foreign body has been removed. If he can see the foreign body in an image of the tissue specimen then this can help him assess the extent to which his efforts to remove a foreign body have been successful.

FIG. 3 also shows robotic arm 30, which can be remotely guided, and used to place a marker in the form of dye, or a metal or plastic clip into specimen 13 to indicate to a lab technician where to take a section. In an alternative preferred embodiment, a person may manually place such a marker.

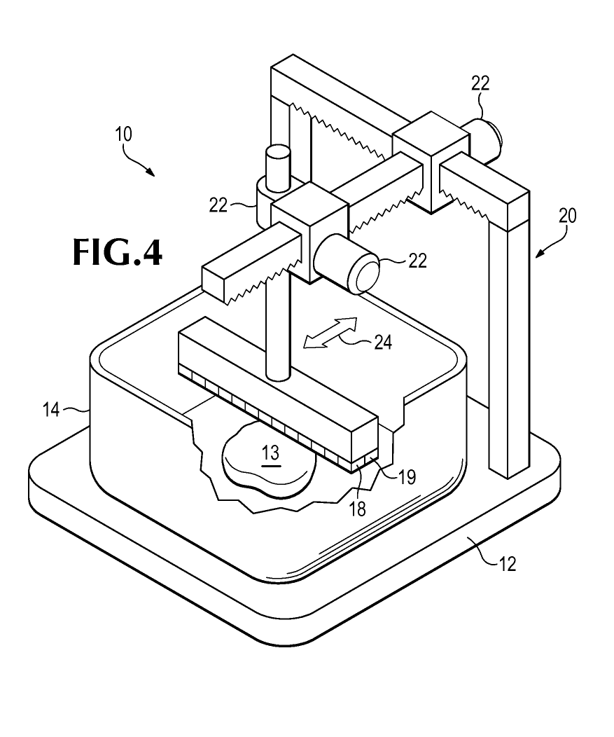

As shown in FIG. 4, an additional transducer array 19, is held on the same assembly as array 18. Array 19 is tuned to transmit and receive at a center frequency of between 18 MHz to 60 MHz (wavelength: approximately 25 to 85 microns), depending on the preferred embodiment implemented. The choice of frequency involves a tradeoff between resolution, which is roughly equal to wavelength, and depth of imaging required. Tissue specimen size is dependent on the purpose of specimen examination and the circumstances under which the tissue specimen is taken. A 50 MHz sound wave can penetrate to a depth of about 1 cm, which may be adequate under many circumstances, but for other tissue specimens a deeper penetration could be highly desirable. On the other hand, some tissue conditions which would suggest a closer examination are evident at the 100 micron resolution range, whereas other conditions require a resolution closer to the size of many human tissue cells, which is in the range of about 5-20 microns. In some cases the specimen will be moved before being imaged with higher resolution array 19. The surfaces of the specimen may be of particular importance in assessing the patient condition as in some instances the specimen will have been generated in an effort to remove a tumor. In this situation, the surface condition may provide an indication as to the complete removal of the tumor. Accordingly, after a first, initial assessment imaging, the specimen can be oriented so that the surface area of greatest interest can be closely examined.

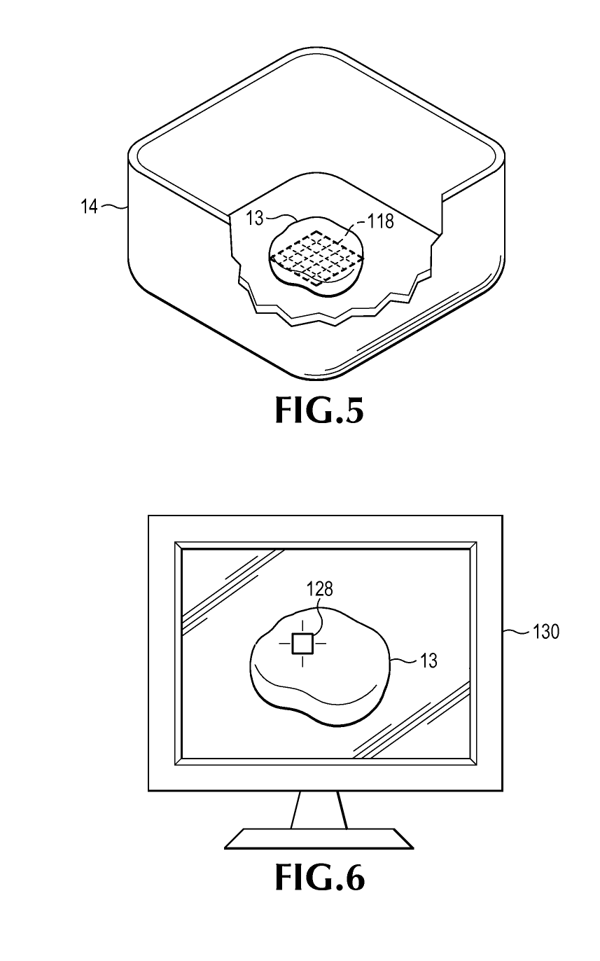

Referring to FIG. 5, in an additional preferred embodiment, a two-dimensional piezoelectric array 118 is used, to form a beam that is narrow and steerable in two orthogonal dimensions. This beam is scanned over the specimen to form a 3-dimensional image, in the two orthogonal dimensions and in range (in other words depth into the specimen). As array 118 does not need to be moved, it may be placed as shown, into the bottom of container 14. Array 118 may be a piezoelectric transceiver or a capacitive micro-machined ultrasonic transducer (CMUT). In one preferred embodiment the specimen is held above the floor of container 14, to give the beam coverage volume from array 118 room to spread out.

In another preferred embodiment, the beam is electronically scanned in one dimension and mechanically scanned in the other, without the second scan shown in FIG. 3. In this embodiment there are many more elements along the dimension that is electrically scanned, and to improve resolution in the mechanically scanned dimension between 3 and 20 elements, which are not electrically steerable, but are fixed in relative intensity to form a beam that is narrower in the horizontally scanned dimension. In another embodiment, the array is essentially square and is electronically scanned in both dimensions. In another preferred embodiment x-rays or infrared light is used, either in conjunction with ultrasound to form a more certain image, or instead of ultrasound. In one preferred method a hand held ultrasound device is used to form an image of a tissue specimen.

In a preferred embodiment, a low frequency device 10 includes a low frequency head and a high frequency head. The low frequency head may be used to form an initial image, with the high frequency head being used to gain a higher resolution image of any areas of interest revealed by the scan with the low frequency head and/or to image the surfaces of the tissue specimen 13, as high frequency ultrasound does not penetrate as far into a tissue specimen as low frequency ultrasound of the same power.

Additionally, the device 10 provides or supports data and image storage. In one preferred embodiment, the device 10 is adapted to be connected to a computer where images can be stored. In another preferred embodiment device 10 includes its own data and image storage device. One great advantage of these embodiments is that before the pathologist cuts into a specimen, thereby partially destroying it, an image set of a specimen feature can be made and stored for future reference. In a preferred embodiment, it is possible to enter additional data into the image. For example, after the pathologist has determined tissue type for a feature apparent in the image formed by device 10, he can associate this tissue type with the feature. In one preferred embodiment, various tissue types can be assigned differing false colors or other indicating characteristics, so that a 3-dimensional map of the specimen can be created.

Referring to FIG. 6, in another preferred embodiment a first health care provider, for example a pathologist, can indicate where to collect tissue sections for microscopic examination, from the specimen, by creating a mark 128 on an electronically displayed three-dimensional image 130 of specimen 13 with a mouse or a computer screen pen. In the context of this application the term “three-dimensional image” includes a two-dimensional image that imparts information about a three-dimensional volume, by perspective and shading. In one embodiment, however, stereoscopic techniques are used to present a truly three-dimensional image to the user. After microscopic imagery has been formed of the tissue sections, it may be related back to the three dimensional imagery, so that a viewer could see the microscopic imagery and at the same time see where in the tissue specimen the tissue section shown in the microscopic imagery originated

In one method, a lab technician runs specimens through device 10 as they come into the laboratory and then a pathologist looks through a set of images marking them for section taking and slide fixing. The technician takes the sections and forms a microscopic image, which is then associated with the image of the specimen 13 with, for example, a line connecting the microscope image to the place on the specimen where the section was taken. The pathologist may then copy the image and mark places on the specimen where it appears to him that the same tissue type may exist.

In another preferred embodiment, software associated with device 10 creates a folder for storage of all information relating to the tissue sample, so that imaging samples and all other information, such as images of microscopic examination of further specimens taken from the tissue specimen, may be stored together and retrieved together. In a variant of this embodiment, a bar code is assigned to this electronic folder, so that a bar code sticker may be placed on a paper file or other physical item, so that a simple scan will retrieve the electronic folder. The identifying bar code (the term bar code is inclusive of any computer readable code, including an RFID chip) may be placed on the specimen container at the time the specimen is collected and associated at that time with the patient. In one preferred embodiment the health care professional collecting and/or handling the tissue sample, enters patient identifying data into a device which prints out a bar code indicating a particular patient, the date and time of specimen collection and any other relevant data concerning the specimen.

Additionally, differences in tissue reflectivity can be highlighted to indicate to an image viewer the location of potential areas of pathology in the tissue specimen. In particular, significant advances have been made recently in the use of ultrasound for tissue characterization. Thus, in many cases, the ultrasound itself can be used to identify regions of interest to the examiner that would not be possible by visual examination alone. This ability to use ultrasound as a unique probe of the characteristics of tissue could be particularly useful for finding very small tumors, for example in the examination of lymph nodes for tumor.

Device 10 may also be used in a surgical setting. During surgery it may be critically important to quickly gain an understanding of the ultrasonic characteristics of any excised lesion. For example, when a tumor is removed, it may be quite difficult to determine if any part of the tumor has been left in the body. By ultrasonically examining the resection (removed tissue), it may be possible to determine if the tumor extends to the surgical margin (the edge of the removed tissue). If it does, then it is likely that the tumor was cut through in the resection, indicating that a portion of the tumor may still be in the patient. Those skilled in the surgical arts are likely to recognize other applications for a penetrating imaging device, located near or in the surgical theater. A preferred embodiment is sized to image tissue specimens ranging from less than 1 square cm, to the size of an organ, such as the spleen or a kidney.

While a number of exemplary aspects and embodiments have been discussed above, those possessed of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. A tissue specimen imaging device, comprising:
a container having an upwardly facing surface, adapted to receive a tissue specimen and a liquid;
an ultrasound imaging assembly, adapted to automatically form a three dimensional image of the tissue specimen interior.

2. The device of claim 1, wherein said ultrasound imaging assembly includes an array of ultrasonic transducer elements capable of electronic scanning in one dimension.

3. The device of claim 1, wherein said transducer elements are piezoelectric elements.

4. The device of claim 2, wherein said ultrasound imaging assembly includes a structure and assembly adapted to move said 1-dimensional piezoelectric array over said tissue specimen.

5. The device of claim 4, wherein said structure and motor causes said 1-dimensional array to scan over said specimen in a first dimension, rotate said array by 90°, and causes said array to scan over said specimen in a second dimension orthogonal to said first dimension.

6. The device of claim 1, wherein said ultrasound imaging assembly includes a two-dimensional transducer array.

7. A method of examining a tissue specimen, comprising:
(a) providing an ultrasound device capable of automatically forming an interior image of said tissue specimen;
(b) using said device to automatically form a three dimensional interior image of said tissue specimen; and
(c) further studying sections of said tissue specimen in reliance on said three dimensional interior image.

8. The method of claim 7, wherein said further studying sections of said tissue specimen includes taking tissue sections from said specimen, fixing said tissue sections on microscope slides and viewing said microscope slides under a microscope.

9. The method of claim 7, further including forming a further set of imagery and relating imagery from each said microscope slide to the place from said tissue specimen where said tissue sections for said microscope slide was taken.

10. The method of claim 7, wherein said image is also stored for future inspection.

11. The method of claim 7, wherein said imaging device makes use of an piezoelectric array.

12. The method of claim 7, wherein said imaging device makes us of a 1-dimensional array that is moved automatically, by operation of machinery, relative to said specimen.

13. The method of claim 7 wherein said device includes a surface for receiving said tissue specimen.

14. The method of claim 7, wherein said device includes a two-dimensional array of ultrasound transducer elements.

15. A method of communicating with a lab technician to indicate where on a tissue specimen to take tissue sections, comprising:
(a) providing and displaying an electronic three-dimensional interior image of said tissue specimen;
(b) electronically marking on said three dimensional interior image of said tissue specimen to indicate desired location of tissue section.

16. The method of claim 15, wherein said tissue section is microscopically imaged and said microscopic image is associated to said position in said specimen as shown in said three-dimensional interior image where said section was taken.

17. The method of claim 15, wherein said tissue section is microscopically imaged and a tissue type is determined and wherein an extent of said tissue type is then marked on said three-dimensional image.

18. The method of claim 15, wherein the marking is performed on a first display screen and electronically communicated to a second display screen, viewed by said lab technician.

19. A method of communicating with a lab technician to indicate where on a tissue specimen to take tissue sections, comprising:
(a) providing and displaying an electronic three-dimensional interior image of said tissue specimen;
(b) marking a location on said tissue specimen to indicate desired location of tissue section.

20. The method of claim 19, wherein said marking is done with dye injected into a portion of said specimen.

21. The method of claim 19, wherein said marking is done with a physical marker inserted into said specimen.
